(19) United States
(12) Patent Application Publication
(10) Pub. No.: US 2006/0088034 A1
(43) Pub. Date: Apr. 27, 2006

(54) Network service classes

(75) Inventor: Ralph Santitoro, Simi Valley, CA (US)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 10/973,174

(22) Filed: Oct. 26, 2004

(51) Int. Cl. H04L 12/56; H04L 12/28

(52) U.S. Cl. 370/395.21

(57) ABSTRACT

The present invention describes a standard way of defining network service classes, which provide default quality of service levels required for corresponding communication applications. The network service classes provide end-to-end quality of service policies that extend across multiple, disparate communication networks, and the network elements therein. In effect, the network elements within these communication networks are provisioned and network performance is engineered for the various network service classes. The various communication applications will be placed into the most appropriate network service class, which will provide at least the minimum quality of service performance requirements for the communication application. As such, communication applications having similar quality of service requirements will be grouped together, instead of having unique quality of service support in the communication networks.

### FIELD OF THE INVENTION

The present invention relates to packet-based communications, and in particular to defining network services classes to which communications for corresponding communication applications are assigned to provide efficient and effective quality of service control.

### BACKGROUND OF THE INVENTION

Quality of service (QoS) is a broad term used to describe the overall experience a user application will receive during communications over a network. QoS involves a broad range of technologies, architectures, and protocols. Network operators achieve end-to-end quality of service by ensuring that network elements apply consistent treatment to traffic flows as packets traverse the network.

Today, network traffic is highly diverse and each traffic type has unique requirements in terms of bandwidth, delay, loss, and availability. With the explosive growth of the Internet, most network traffic currently is Internet Protocol (IP) based. Having a single end-to-end transport protocol is beneficial, because networking equipment becomes less complex to maintain, which results in a lower operating cost. This benefit, however, is countered by the fact that IP is a connectionless protocol, wherein IP packets do not take a specific path as they traverse the network. This results in unpredictable quality of service and a best effort network.

The Internet Protocol was originally designed to reliably get a packet to its destination with less consideration to the amount of time it takes to get there. IP networks must now support many types of applications. Many of these applications require low latency; otherwise, the end user quality may be significantly affected, or in some cases, the application simply does not function at all.

Voice applications originate on public telephone networks using Time Division Multiplexing (TDM) technology, which has a very deterministic behavior. On TDM networks, the voice traffic experiences a low and fixed amount of delay with essentially no loss. Voice applications require this type of behavior to function properly, while also requiring the same level of “TDM voice” quality to meet user expectations.

When voice is transported over a best effort IP network, the IP network introduces a variable and unpredictable amount of delay to the voice packets, and also drops voice packets when the network is congested. Thus, the best effort IP network does not provide the behavior that the voice application requires. Quality of service technologies can be applied to the best effort IP network to make it capable of supporting voice over IP with acceptable, consistent, and predictable voice quality.

Notably, there are numerous types of applications requiring communications over various types of networks. These applications may support communications between people or between a person and a network device application, such as a personal computer or web server. Other applications may support communications between networking devices, such as from server to server or from router to router. Unfortunately, these applications may have very different quality of service performance requirements. The table below illustrates the various quality of service performance requirements for select communication applications.

TABLE 1
Quality of Service Performance Requirements

| | QoS Performance Requirements | | | |
|---|---|---|---|---|
| | | Sensitivity to | | |
| Application | Bandwidth | Delay | Jitter | Loss |
| VoIP | Low | High | High | High |
| Video Conferencing | High | High | High | Med-High |
| Streaming Video on Demand | High | Med | Low | Med-High |
| Streaming Audio | Low | Med | Low | Med |
| Client/Server Transactions | Med | Med | Low | Med |
| Email | Low | Low | Low | Med |
| File Transfer | Med | Low | Low | Med |

Notably, the communications network can introduce a moderate amount of loss and still provide good quality of service for client/server transactions, email, and file transfer applications, since these applications use the Transmission Control Protocol (TCP), which will detect lost packets and retransmit them. This is why some applications, including Client/Server, Email and File Transfer applications, can tolerate a moderate amount of loss as indicated in Table 1. In addition to the numerous communication applications having very different quality of service requirements, an end-to-end communication session may span multiple and disparate types of communication networks, which use different techniques to control quality of service. The quality of service control generally depends on the type of information being transported, subscriber service level agreements, or network policy agreements, and are applied within the layer 2 or layer 3 protocols. Unfortunately, any given network is generally only concerned with quality of service control within that network, and does not take into consideration the quality of service requirements or actions taken in adjacent yet disparate communication networks. Thus, there is significant difficulty associated with applying consistent quality of service standards for communications spanning disparate types of communication networks.

### SUMMARY OF THE INVENTION

The present invention describes a standard way of defining end-to-end network service classes, which provide default quality of service levels required for corresponding communication applications. The network service classes provide end-to-end quality of service policies that extend across multiple, disparate communication networks and the network elements therein. In effect, the network elements within these communication networks are provisioned and network performance is engineered for the various network service classes. The various communication applications are placed into the most appropriate network service class, which will provide at least the minimum quality of service performance requirements for the communication application. As such, communication applications having similar quality of service requirements will be grouped together, instead of having unique quality of service support in the communication networks.

In operation, an edge device will analyze incoming packets, and monitor aspects of these packets to select a network service class based on packet parameters, which may include the type of content being carried or other information indicative of the relative quality of service needed. Headers of the packets are marked to reflect the quality of service parameters for the selected network service class, and the packets are routed toward their destination. Routing nodes within the communication networks receiving the marked packets will analyze the markings and process the packets according to the markings. In one embodiment, these markings are simply standardized protocol markings, which are readily recognized and processed by the routing nodes within the communication networks. As such, the routing nodes within disparate types of communication networks do not need to recognize specialized or proprietary quality of service markings, but will simply route the packets using standard quality of service markings associated with the protocol, because the edge device has determined the appropriate quality of service for the identified network service class. Multiple markings may be applied to a single packet, wherein different protocols at different layers may be used for routing packets across different communication networks.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment configured according to one embodiment of the present invention.

FIG. 2 illustrates an exemplary process for handling packet traffic according to one embodiment of the present invention.

FIG. 3 is a table illustrating exemplary network service classes.

FIG. 4 is a table illustrating exemplary marking techniques by protocol associated with network service classes.

FIG. 5 is a block representation of a communication client according to one embodiment of the present invention.

FIG. 6 is a block representation of an edge device according to one embodiment of the present invention.

FIG. 7 is a block representation of a routing node according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention defines network service classes that are associated with default quality of service parameters. Each network service class is associated with different quality of service parameters, and communication applications are associated with the network service classes depending on the required quality of service for associated communication sessions. Thus, traffic for communication sessions will be classified and placed into an appropriate network service class and routed through the various communication networks based on the network service class quality of service parameters and associated network engineering. Details regarding the network services classes, classifying network traffic, and routing the traffic according to the selected network service class follow.

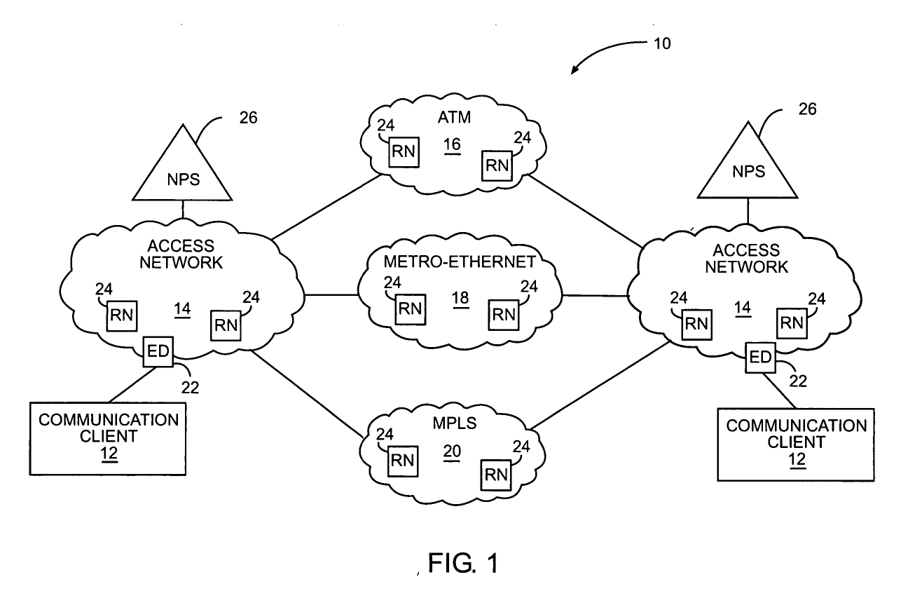

Turning now to FIG. 1, a communication environment according to one embodiment of the present invention is illustrated. The communication environment 10 supports Internet Protocol (IP) services and allows unidirectional or bidirectional communication sessions to be established between communication clients 12 through one or more communication networks, such as an access network 14 providing traffic access or aggregation, Asynchronous Transfer Mode (ATM) network 16, metro-Ethernet network 18, and Multi-Protocol Label Switching (MPLS) network 20. As illustrated, edge devices (EDs) 22 provide access to the access networks 14, which are coupled together through the ATM, metro-Ethernet or MPLS networks 16, 18, and 20. Those skilled in the art will recognize that the edge devices 22 may be coupled to any type of communication network that supports wired or wireless communications, and may be coupled to the communication clients 12 through any type of communication network, including various types of access networks, such as cable, digital subscriber line (DSL), integrated services digital network (ISDN), cellular, wireless local area network (WLAN), broadband fixed wireless (WiMax) or other wired or wireless network. Further, the communication clients 12 may represent a subscriber endpoint, such as a telephony device, personal digital assistant (PDA), personal computer, or other communication device, as well as a content or service provider server, which is capable of delivering and receiving various types of content. The communication sessions themselves may be data, audio, video, or voice based sessions.

The edge devices 22 may take the form of any type of router, switch, or gateway that facilitates the interworking between disparate types of networks. The edge devices 22 may also represent aggregation points, wherein media flows from multiple communication clients 12 are channeled into an appropriate communication format for transfer over the adjacent communication network. Further, the various communication networks will include various routing nodes (RNs) 24, which may represent routers, switches, or other routing entity through which packet traffic is routed when routed through the various communication networks and between the various communication clients 12 or edge devices 22. Network policy servers (NPSs) 26 may be used to implement service policies and control access to the networks and allocation of network resources based on subscriber, network, or service provider policies.

For the present invention, various levels of quality of service are defined and associated with different network service classes, which are essentially different quality of service categories. Various communication applications require different levels of quality of service, and as such, the applications will be assigned to the most appropriate network service class, which will fulfill the quality of service requirements for that particular communication application. When communication sessions are established in association with a particular communication application, the traffic for the communication session will be classified and placed into the appropriate network service class and routed through the one or more communication networks. The traffic will be marked to identify the network service class, such that the routing nodes 24 and the various communication networks can quickly determine the relative level of quality of service required by the traffic, and process the traffic accordingly.

In general, the edge devices 22 will monitor incoming traffic, determine a network service class, and mark the packets making up the traffic in a manner such that the various communication networks can process the traffic according to the desired quality of service levels. Since the traffic passes through different types of communication networks, the packets may be marked according to different protocols and in a different protocol layer so that the markings may be easily detected by the communication networks during processing and routing. Thus, the edge devices 22 will classify the traffic and mark it in a way in which the routing nodes 24 can readily detect the appropriate quality of service level to apply for the traffic. As such, there is no need to reclassify the traffic once the edge device 22 has classified and marked the packets associated with the traffic. Since the packets are marked for the various protocols and protocol layers, the routing nodes 24 in the different communication networks can readily determine the quality of service levels required for the traffic.

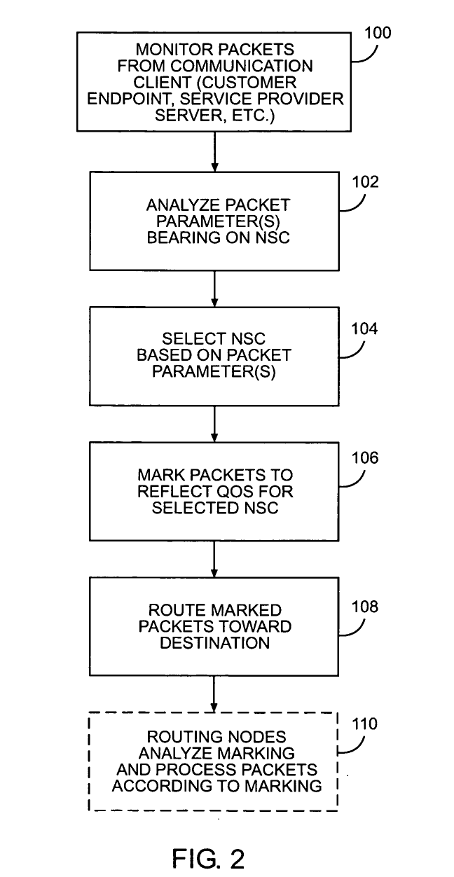

Turning now to FIG. 2, a detailed flow diagram is provided for classifying and marking packets in the edge device 22. Initially, the edge device 22 will monitor packets from a communication client 12, which may be a customer endpoint, service provider server, or other communication entity (step 100), and analyze packet parameters bearing on an appropriate network service class (step 102). The analysis may take into consideration the type of content, the communication application associated with the packets, and the subscriber's service level agreement (SLA) to determine the requisite quality of service required for the packets. Based on the packet parameters, and inherently upon the required quality of service level for the packets, the edge device 22 will select an appropriate network service class (step 104). At this point, the edge device 22 will mark the packets in a manner reflecting the required quality of service for the selected network service class in light of the potential communication networks through which the packets will travel (step 106). As such, the packets may be marked in multiple and different ways according to the protocols or protocol layers that are used in the various communication networks for routing the packets. However, the different protocol or protocol layer markings are applied consistently across each communications network. For example, if the packets were routed through access networks 14 and the MPLS network 20, the packets would be marked such that the access networks 14 and the MPLS network 20 can readily recognize the markings without special configuration to determine the relative quality of service level for the packets. Once marked, the packets are routed towards their destination (step 108). At this point, the routing nodes 24 will use their native protocol processing capabilities to analyze the markings provided by the edge devices 22 and process the packets according to the markings in the corresponding protocols and protocol layers (step 110).

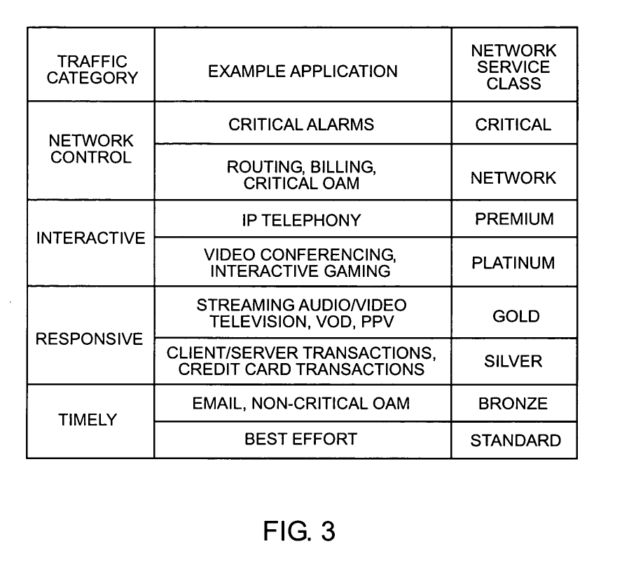

For defining quality of service parameters for multiple types of communication networks, there are different technologies, standards, and network architectures to consider. There is no single quality of service technology or standard that can be used to cross disparate types of networks. With reference to FIG. 3, exemplary network services classes are defined to provide appropriate quality of service for different types of applications. Service providers or network managers will determine the services to be offered or the applications supported. Based on this information, the edge devices 22 are configured to essentially place the traffic into the network service class that provides the closest quality of service required by the application or service being offered. Once the network service classes are defined, services can be quickly added using the predefined network service classes without having to specifically address the underlying quality of service technologies used in the particular communications network, since the edge devices 22 and the other routing nodes 24 throughout the various communication networks are preconfigured to provide the requisite quality of service defined by the network service classes.

The network service class architecture illustrated in FIG. 3 provides for eight different types of network service classes: critical, network, premium, platinum, gold, silver, bronze, and standard. These eight names are used for illustrative purposes only and can be described using alternative nomenclature. These network service classes generally correspond to four types of traffic categories, which include network control, interactive, responsive, and timely. The network control category may relate to critical network alarms, routing, billing, and operations, administration, and maintenance (OAM) applications within the confines of a provider's communications network or between communications network providers. The remaining three categories are for traffic initiated or terminated by the subscriber. The interactive category may include IP telephony, video conferencing, and interactive gaming applications and services. The responsive category may include streaming audio and video, television, video on demand (VOD), pay-per-view (PPV), and client/server transactions. The timely category may include email, non-critical OAM, and other best effort applications with minimal or no quality of service requirements.

The network control category applications require a relatively low amount of delay, and loss needs to be minimized. Interactive category applications expect a network to provide packets with the lowest possible delay, jitter, and loss. Responsive category applications expect the network to provide packets with a relatively low amount of delay, jitter, and loss. Timely category applications expect a network to provide packet with a bounded amount of delay and loss. Jitter has a negligible effect on the timely category associated applications, and loss is essentially reduced to zero because of available retransmission and recovery mechanisms used by most applications in the timely category. The various applications may be split into different network service classes as defined. For example, IP telephony may be assigned to the premium network service class, wherein streaming audio, video, and television services may be assigned to the gold network service class.

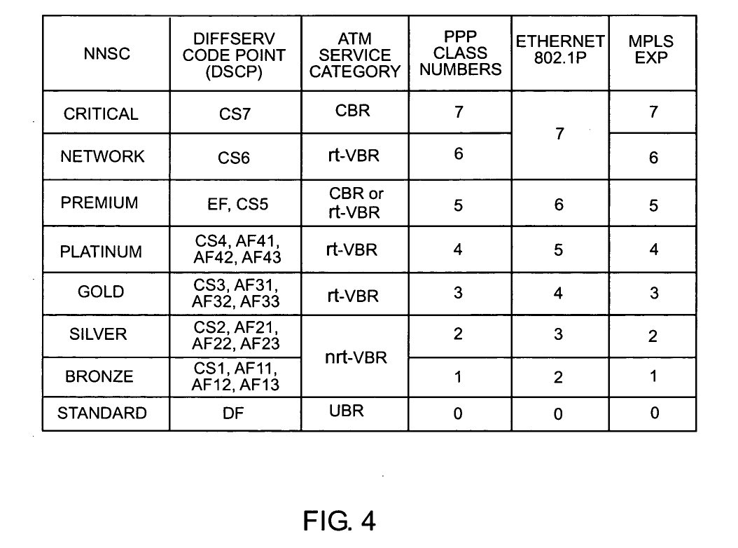

As described above, the edge devices 22 will analyze the traffic for a given quality of service session, and analyze parameters associated therewith to determine the network service class to which the traffic should be assigned. Once the network service class is selected, the packets are marked so that the routing nodes 24 or other devices can readily determine the quality of service parameters required for the individual packets, which will correspond to the assigned network service class. In essence, marking may take place by changing or adding header information in each packet corresponding to the appropriate protocol and protocol layer, which may be analyzed by various routing nodes 24 over the different communication networks. The Internet Engineering Task Force (IETF) differentiated services (DiffServ) architecture is typically used in the access networks 14, wherein the edge devices 22 will modify the packet headers to include a DiffServ code point (DSCP), which best corresponds to the appropriate network service class as shown in FIG. 4. DiffServ provides quality of service in layer 3 of the protocol stack. For the ATM network 16, the packets (or cells) will include an ATM service category that will correspond to the most appropriate network service class. ATM service categories generally control quality of service in layer 2 of the protocol stack. Similarly, point to point protocol (PPP) class numbers are used to identify the quality of service over digital subscriber line (DSL), Frame Relay or time division multiplex (TDM) networks. Routing nodes in the metro-Ethernet network 18 may use the IEEE's 802.1p user priority to identify the quality of service, wherein select values are assigned to the most appropriate network service classes. The IEEE 802.1p user priority markings are used in layer 2 of the protocol stack. The MPLS network 20 may use EXP bits, which have values corresponding to an appropriate network service class. In general, it is thought that the MPLS quality of service is controlled at layer 2.5, which is effectively a hybrid between layers 2 and 3.

Accordingly, applications are assigned to the most appropriate network service class. The edge device 22 will classify the packet, and mark it such that the quality of service provided by the routing nodes 24 and any of the communication networks will provide a quality of service corresponding to the network service class. Notably, the routing nodes 24 do not need to know what the network service class is. The routing nodes 24 only need to know how to recognize the marking indicia in the packets and determine the appropriate quality of service required for the packet based thereon. The routing nodes 24 will essentially operate in traditional fashion using the traditional protocols. As such, the use of network service classes pulls together various quality of service standards and technologies in a meaningful way, allowing network service providers to provide standardized quality of service over different types of networks.

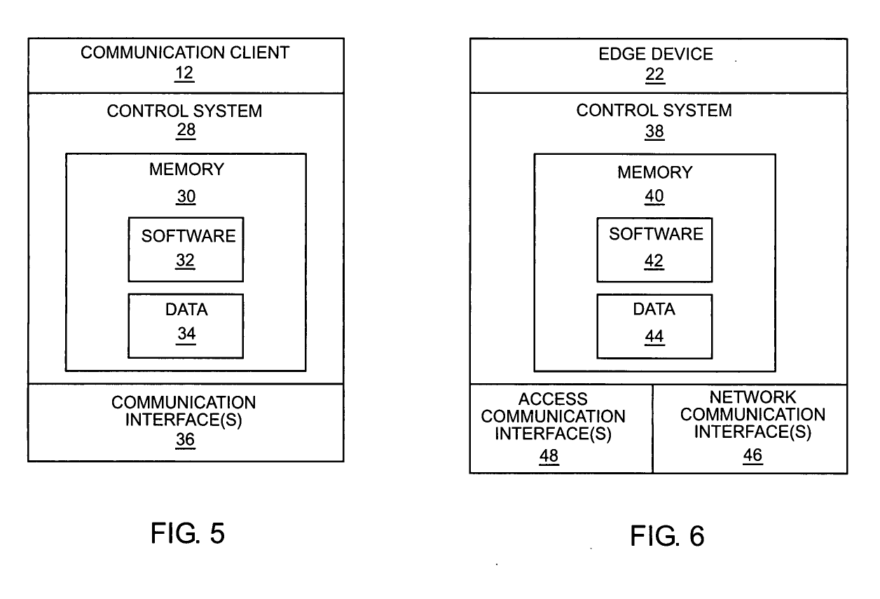

Turning now to FIG. 5, a block representation of a communication client 12 is illustrated. The communication client 12 will include a control system 28 having memory 30 with the requisite software 32 and data 34 to operate as described above. The control system 28 will also be associated with one or more communication interfaces 36 to facilitate either wired or wireless communications, depending on the particular embodiment. Again, the communication client 12 may represent a subscriber communication device, service provider server, or any other device at which packets are sent or received in association with a communication session.

An edge device 22 is illustrated in FIG. 6 as including a control system 38 with memory 40 having the requisite software 42 and data 44 to operate as described above. The control system 38 may be associated with one or more network communication interfaces 46 for facilitating communications over a communication network, as well as one or more access communication interfaces 48 for facilitating communications with the communication clients 12 over various types of access networks.

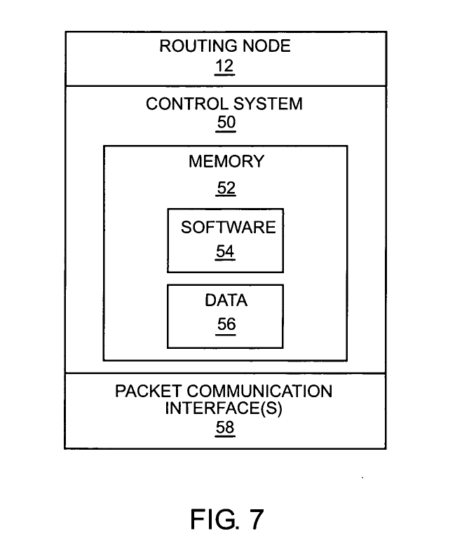

An exemplary routing node 24 is illustrated in FIG. 7 as including a control system 50 having sufficient memory 52 for the requisite software 54 and data 56 to facilitate routing of packets as described above. The control system 50 will be associated with one or more packet communication interfaces 58 to enable routing or switching of packets through the appropriate communication network, which may include the access networks 14, ATM network 16, metro-Ethernet network 18, and MPLS network 20.

Those skilled in the art will recognize improvements and modifications to the preferred embodiments of the present invention. All such improvements and modifications are considered within the scope of the concepts disclosed herein and the claims that follow.

What is claimed is:

1. A method comprising:
monitoring incoming packets;
analyzing parameters of the packets;
selecting a network service class from a plurality of network service classes based on the parameters of the packets;
marking the packets with quality of service indicia corresponding to the network service class to control quality of service provided for the packets during routing over at least one communication network; and
routing the packets towards their destinations over the at least one communication network.

2. The method of claim 1 wherein the plurality of network service classes correspond to a plurality of predefined quality of service categories to which the packets are assigned prior to routing by marking the packets with the quality of service indicia.

3. The method of claim 2 wherein different types of communication applications are assigned to different ones of the network service classes based on quality of service requirements for communication sessions for the communication applications.

4. The method of claim 1 wherein certain of the packets are routed over at least two of the communication networks and the at least two of the communication networks use different communication protocols.

5. The method of claim 4 wherein the packets are marked with different quality of service indicia for each of the different communication protocols.

6. The method of claim 5 wherein at least two of the different communication protocols reside at different protocol layers and wherein the packets are marked with the different quality of service indicia at the different protocol layers.

7. The method of claim 1 wherein the packets are routed to their destinations over the at least one communication network without changing the network service class.

8. The method of claim 1 wherein the packets are routed to their destination over the at least one communication network using the quality of service indicia.

9. The method of claim 1 wherein the quality of service indicia is a differential services code point, which corresponds to the network service class.

10. The method of claim 1 wherein the quality of service indicia is an asynchronous transfer mode service category, which corresponds to the network service class.

11. The method of claim 1 wherein the quality of service indicia is an Ethernet 802.1p user priority, which corresponds to the network service class.

12. The method of claim 1 wherein the quality of service indicia is a point to point protocol (PPP) class number, which corresponds to the network service class.

13. The method of claim 1 wherein the quality of service indicia is a Multi-Protocol Label Switching (MPLS) EXP bit, which corresponds to the network service class.

14. A system comprising:
at least one communication interface; and
a control system associated with the at least one communication interface and adapted to:
monitor incoming packets;
analyze parameters of the packets;
select a network service class from a plurality of network service classes based on the parameters of the packets;
mark the packets with quality of service indicia corresponding to the network service class to control quality of service provided for the packets during routing over at least one communication network; and
route the packets towards their destinations over the at least one communication network.

15. The system of claim 14 wherein the plurality of network service classes correspond to a plurality of predefined quality of service categories to which the packets are assigned prior to routing by marking the packets with the quality of service indicia.

16. The system of claim 15 wherein different types of communication applications are assigned to different ones of the network service classes based on quality of service requirements for communication sessions for the communication applications.

17. The system of claim 14 wherein certain of the packets are routed over at least two of the communication networks and the at least two of the communication networks use different communication protocols.

18. The system of claim 17 wherein the packets are marked with different quality of service indicia for each of the different communication protocols.

19. The system of claim 18 wherein at least two of the different communication protocols reside at different protocol layers and wherein the packets are marked with the different quality of service indicia at the different protocol layers.

20. The system of claim 14 wherein the packets are routed to their destinations over the at least one communication network without changing the network service class.

21. The system of claim 14 wherein the packets are routed to their destination over the at least one communication network using the quality of service indicia.

22. The system of claim 14 wherein the quality of service indicia is a differential services code point, which corresponds to the network service class.

23. The system of claim 14 wherein the quality of service indicia is an asynchronous transfer mode service category, which corresponds to the network service class.

24. The system of claim 14 wherein the quality of service indicia is an Ethernet 802.1p user priority, which corresponds to the network service class.

25. The system of claim 14 wherein the quality of service indicia is a point to point protocol (PPP) class number, which corresponds to the network service class.

26. The system of claim 14 wherein the quality of service indicia is a Multi-Protocol Label Switching (MPLS) EXP bit, which corresponds to the network service class.

27. A computer readable media having software comprising instructions for a control system to:
monitor incoming packets;
analyze parameters of the packets;
select a network service class from a plurality of network service classes based on the parameters of the packets;
mark the packets with quality of service indicia corresponding to the network service class to control quality of service provided for the packets during routing over at least one communication network; and
route the packets towards their destinations over the at least one communication network.
